(19) United States
(12) Patent Application Publication
(10) Pub. No.: US 2015/0379453 A1
(43) Pub. Date: Dec. 31, 2015

(54) SYSTEM AND METHOD FOR EVALUATING EMPLOYEES AND JOB SEEKERS AT AN ORGANIZATION

(71) Applicant: Bradley A. Myers, Salem, OH (US)

(72) Inventor: Bradley A. Myers, Salem, OH (US)

(21) Appl. No.: 14/314,701

(22) Filed: Jun. 25, 2014

(51) Int. Cl. G06Q 10/06; G06Q 10/10

(52) U.S. Cl. CPC G06Q 10/06398; G06Q 10/1053

(57) ABSTRACT

A pool of data points or employment metrics are acquired and stored for employees of an organization on an ongoing basis and used for performance feedback to the organization. A first set of employment metrics in the pool of employment metrics are used to determine a performance score of a particular employee. The performance score is then used to analyze and correlate the remaining employment metrics in the pool to determine which employment metrics indicate the performance score. The employment metrics indicative of the performance score are then used to determine a success indicator for the employee. The formula created to derive a success indicator from employment metrics indicative of performance score may then be used in evaluating a job seeker at the organization by converting the data provided by the job seeker into a success indicator.

### BACKGROUND OF THE INVENTION

1. Technical Field

The present invention relates to evaluating employees at an organization as well as job seekers seeking employment at the organization. More particularly, the present invention relates to using employment metrics of employees to derive performance scores and success indicator values. Specifically, the present invention relates to determining a performance score for each employee at an organization and using this performance score along with additional employment metrics to derive a success indicator value for each employee as well as job seekers.

2. Background Information

Employers constantly face the issue of properly evaluating talent for employment before actually hiring the talent. Getting to know a potential employee is a difficult task and hiring the wrong person can be devastating to a company. Many hiring decisions at smaller or more informal companies are done on an ad hoc or case-by-case basis, typically with a manager or owner reviewing resumes and meeting with promising candidates face-to-face. Other companies have more formalized procedures, such as an automated resume collection and review system. Recently, some companies have tried to incorporate assessment tests into the hiring decisions, including those that give some insight into the personality of the potential employee. Even armed with this information, companies rarely have insight into how this information correlates to a particular position within the company. Thus, there is great need in the art to provide a mechanism for evaluating talent and applying this information to specific positions within the company to help determine which potential employees to hire.

### BRIEF SUMMARY OF THE INVENTION

In one aspect, the invention may provide a method for evaluating a plurality of employees in an organization, the method comprising the steps of: selecting a first set of employment metrics from a pool of employment metrics for each employee in the plurality of employees in the organization; converting the first set of employment metrics for each employee in the plurality of employees into a performance score for the employee; selecting a second set of employment metrics from the pool of employment metrics by correlating the performance score of each employee in the plurality of employees with each employment metric in the pool of employment metrics to determine which employment metrics in the pool of employment metrics are indicative of the performance score; converting the second set of employment metrics for each employee in the plurality of employees into a success indicator for the employee; and providing the performance score and the success indicator for each employee in the plurality of employees to the organization.

In another aspect, the invention may provide a system comprising: a database, wherein the database includes a plurality of data records, wherein a first data record in the plurality of data records represents a current employee at an organization, a performance score for the current employee, a success indicator for the employee, and a pool of variables associated with the current employee; a conversion module in communication with the database, wherein the conversion module is configured to convert a first plurality of variables in the pool of variables for the current employee into the performance score and store the performance score in the database; wherein the conversion module is configured to correlate the performance score with the remaining variables in the pool of variables not in the first plurality of variables to determine which of the remaining variables in the pool of variables are indicative of the performance score and to consider the indicative variables as members of a second plurality of variables in the pool of variables; and wherein the conversion module is configured to convert the second plurality of variables in the pool of variables for the current employee into the success indicator and store the success indicator in the database.

In another aspect, the invention may provide a method of evaluating a job seeker for an employment position at an organization, the method comprising the steps of: associating a first set of employment metrics with each employee in a plurality of employees in the organization; associating a second set of employment metrics with each employee in the plurality of employees; converting the first set of employment metrics for each employee in the plurality of employees into a performance score for the employee; determining a weight for each employment metric in the second set of employment metrics by comparing the differences between the performance score of each employee in the plurality of employees and the associated second set of employment metrics of the employee; acquiring a value for at least one employment metric in the second set of employment metrics for the job seeker; converting the at least one employment metric in the second set of employment metrics into a success indicator by applying the determined weight for the at least one employment metric in the second set of employment metrics; and providing the success indicator to the organization.

### BRIEF DESCRIPTION OF THE SEVERAL VIEWS OF THE DRAWINGS

One or more preferred embodiments that illustrate the best mode(s) are set forth in the drawings and in the following description. The appended claims particularly and distinctly point out and set forth the invention.

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagram of an embodiment of a system of the present invention;

FIG. 2 is a diagram of an employment positions database table stored in the system;

FIG. 3 is a diagram of an employee records database table stored in the system;

FIG. 4 is a diagram of a job seeker records database table stored in the system;

FIG. 5 is a flow chart of a method of the system; and

FIG. 6 is a flow charge of a method of the system.

Similar numbers refer to similar parts throughout the drawings.

### DETAILED DESCRIPTION OF THE INVENTION

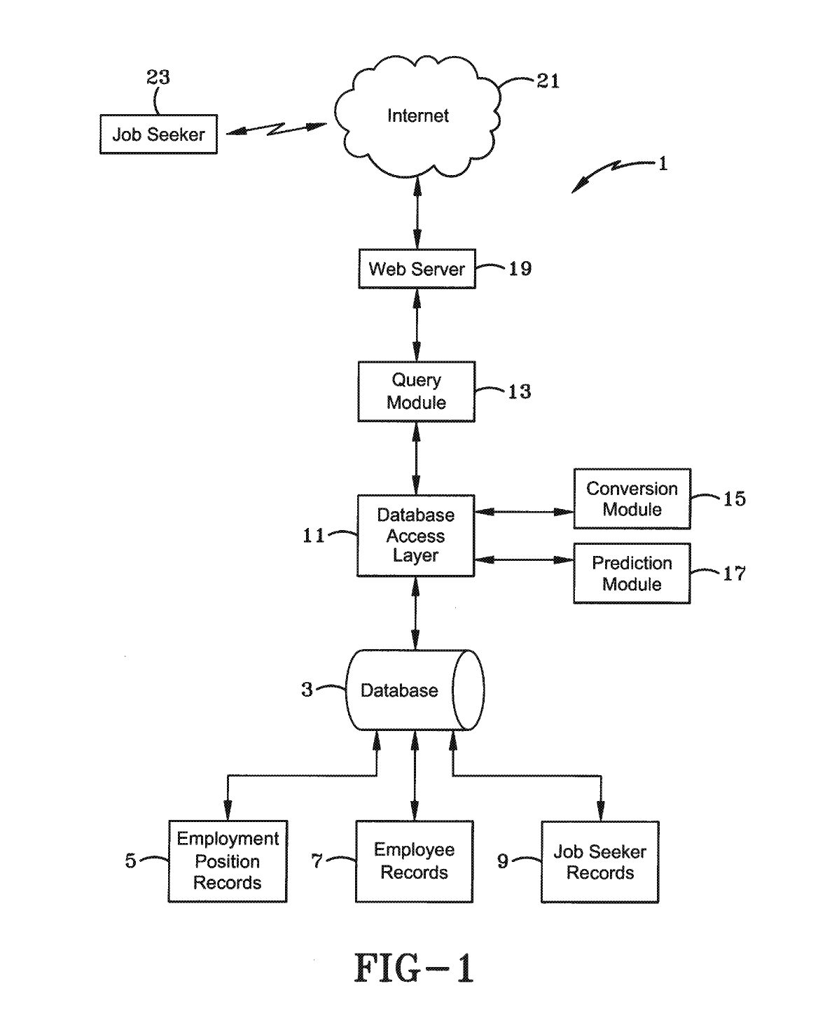

A system and method for evaluating employees and job seekers for employment at an organization is shown in FIGS. 1-6 and referred to generally herein as system 1. Various non-novel features found in the prior art relating to general industrial psychology and computer systems and are not discussed herein. The reader will readily understand the fundamentals of general human resource principles are well within the prior art and readily understood by one familiar therewith.

As shown in FIG. 1, system 1 is used by an organization 2 and includes a database 3 for use in acquiring and maintaining database tables and records. Specifically, database 3 includes a plurality of employment position records 5, a plurality of employee records 7, and a plurality of job seeker records 9. Database 3 is preferably a relational database and provides linking keys between relevant records or tables in database 3. For example, each employment position record 5 may include a reference key to a particular department in organization 2, a geographic location, or any other relevant information. Employment position records 5 may include any other information regarding organization 2. Alternatively, other organizational specific information or necessary supporting information may be contained in other records or databases within system 1. System 1 encompasses any potential mechanism for encapsulating necessary data regarding organization 2 and storing this information for convenient retrieval.

Components of system 1 interface with database 3 through a database access layer 11. The primary elements interacting with database 3 through database access layer 11 are a query module 13, a conversion module 15, and a prediction module 17. Query module 13 interfaces with a webserver 19 which is accessible through the Internet 21. A job seeker 23 accesses webserver 19 through internet 21 to interact with query module 13.

One or more of query module 13, conversion module 15, and prediction module 17 may be encapsulated standalone executable files running in memory, one or more modules may be a subroutine of the overall system 1, or one or more modules may be integrated with system 1. Query module 13, conversion module 15, and prediction module 17 are logical differentiations in the described embodiment and are described separately primarily for exemplary purposes. System 1 may provide query module 13, conversion module 15, and prediction module 17 in one executable file running on one computer system or any other similar computing methodology.

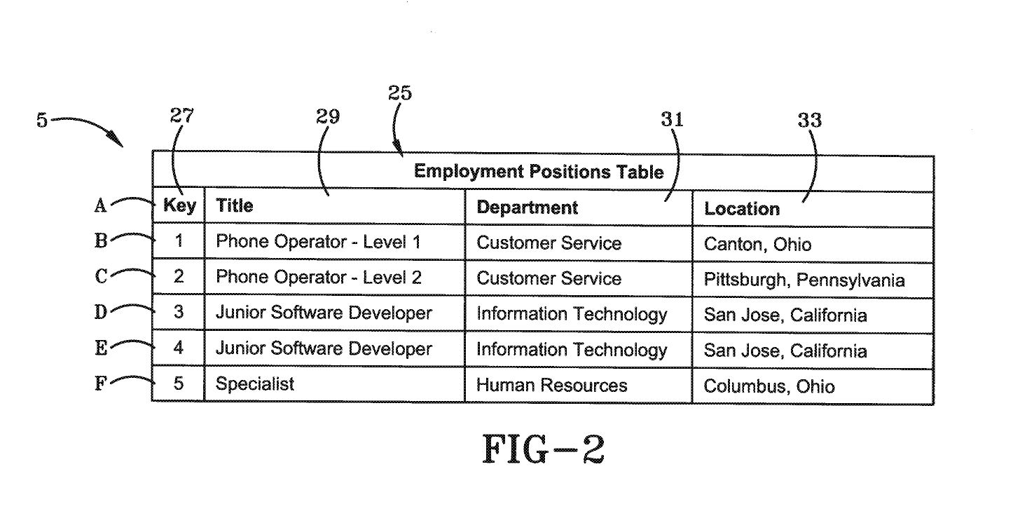

As shown in FIG. 2, employment position records 5 may be represented by an employment position records table 25 within database 3. Employment position records table 25 may include a reference key 27 for use in relating records within employment position records table 25 with other tables within database 3. Employment position records table 25 may also include a column for representing job titles 29. For example, row C represents information relating to the position of “Phone Operator—Level 2”. Employment position records table 25 also includes a column specifying a department 31 where the position is categorized. Employment position records table 25 further includes a column describing a location 33 of the relative position. For example, row E represents an employment position whereby title 29 is “Senior Software Developer”, department 31 is “Information Technology”, and location 33 of this particular position is “San Jose, Calif.”. Any other relevant data relating to employment positions within organization 2 may be recorded within employment position records table 25. Employment position records table 25 of FIG. 2 is for exemplary purposes and may be stored within database 3 in other similar configurations.

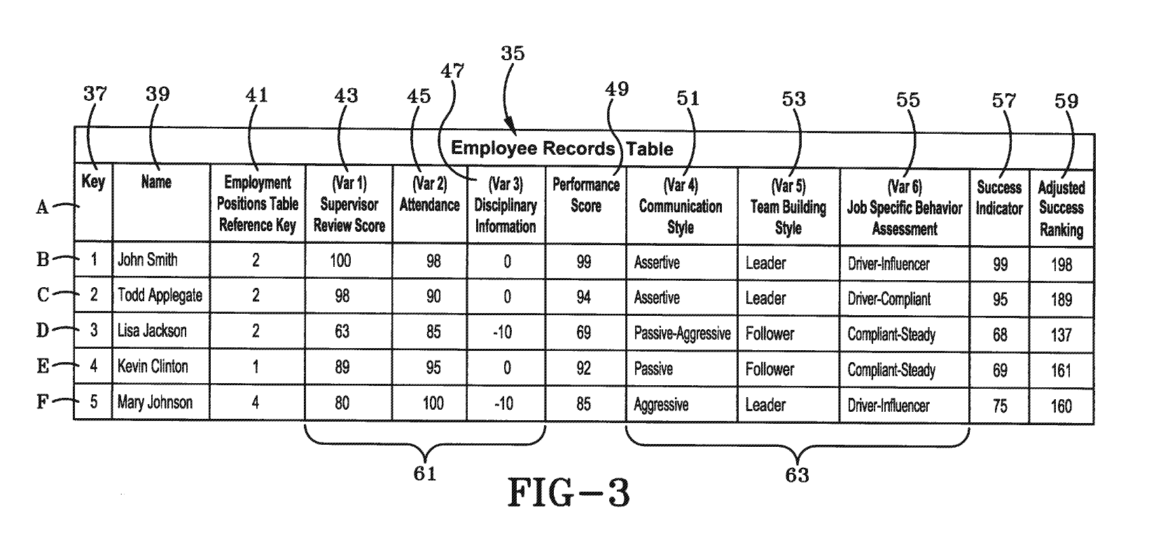

As shown in FIG. 3, employee records 7 may be represented by an employee records table 35 within database 3. Employee records table 35 may include a reference key 37 for use in relating records within employee records table 35 with other tables within database 3. Employee records table 35 includes a column for representing an employee's name 39. Employee records table 35 may also include a column containing an employment positions table reference key 41. The contents of this column is a reference key relating back to employment positions table 25, and specifically the column representing the unique keys 27. For example, row B within employee records table 35 includes “John Smith” within the name 39 column and “2” within the employment positions table reference key 41 column. Referencing FIG. 2 and employment positions table 25, key 2 specifies this employee is a phone-operator—level 2 within the customer service department and located in Pittsburgh, Pa. Employee records table 35 further includes a column for storing information relating to a supervisor review score 43, attendance 45, and disciplinary information 47. Employee records table 35 further includes a column relating to a performance score 49, discussed in greater detail below. Employee records table 35 further includes a column relating to communication style 51, team building style 53, and job specific behavior assessment 55. Employee records table 35 further includes a column relating to success indicator 57 and adjusted success ranking 59, which will be discussed in greater detail below. Employee records table 35 further includes additional data points relating to the individual employee (not shown) which along with the aforementioned described data points, may be referred to as a pool of employment metrics for each employee in the organization. In this example embodiment of system 1, supervisor raw score 43, attendance 45, and disciplinary information 47 comprise a first set of employment metrics 61 from the pool of employment metrics from each employee represented thereby. Similarly, communication style 51, team building style 53, and job specific behavior assessment 55 comprise a second set of employment metrics 63 from the pool of employment metrics for each employee in the organization.

System 1 includes a method for evaluating the employees in organization 2. The first step in this method is selecting a set of metrics from the pool of employment metrics. The selection process may be done by a management group within organization 2 or by an automated process within system 1, or by any other process. As shown in FIG. 3, supervisor raw score 43, attendance 45, and disciplinary information 47 are grouped into first set of employment metrics 61 and represent the selected metrics from the pool of employment metrics. The next step in the method for evaluating employees is to convert first set of employment metrics 61 into performance score 49 for each employee. This conversion may be by way of an algorithm developed within organization 2 specifically for this purpose or may be a general summation of the values of first set of employment metrics 61 or may be any other method of correlating the information within first set of employment metrics 61 to arrive at a value used for performance score 49. For example, performance score 49 of FIG. 3 is calculated using the general formula of:

(supervisor review score 43+attendance 45+disciplinary information 47)/2=performance score 49

This simple formula provides a relative ranking of each employee within employee records table 35 based upon whatever values are contained within first set of employment metrics 61. The data points contained within first set of employment metrics 61 may be added or subtracted by organization 2 or may be updated by an underlying background process running within system 1 for determining which data points within the pool of employment metrics are indicative of the employee's performance within organization 2.

The next step in the method for evaluating the employees of organization 2 is generally directed to determining which remaining employment metrics in the pool of employment metrics are indicative of or beneficial in determining the performance score. System 1 therefore includes logic for determining correlational properties between performance score 49 and the remaining employment metrics within the pool of employment metrics not found within first set of employment metrics 61. The employment metrics are analyzed utilizing multiple statistical techniques, including, but not limited to, logical regression statistical analysis. Significant employment metrics are identified and used to create a second set of employment metrics 63. The organization 2 may determine a time span and recalculate or reanalyze employment metrics within the pool of employment metrics for every elapsed amount of time equal to the time span to constantly or frequently update the analysis and statistical correlation between performance score 49 and any employment metrics in the pool of employment metrics which should be contained within second set of employment metrics 63. For exemplary purposes, communication style 51, team building style 53, and job-specific behavior assessment 55 are shown as employment metrics contained within second set of employment metrics 63. While not required within system 1, generally first set of employment metrics 61 are directed to “hard metrics” which may provide a raw numerical value. Conversely, second set of employment metrics 63 may be directed towards more “soft metrics” which may be a non-numerical value directed to variables such as personality types and communication styles.

The next step in the method for evaluating employees within organization 2 is to convert second set of employee metrics 63 into a success indicator 57 for the employee. This formula is a formula derived from the step of correlating and analyzing which employment metrics may be used to indicate and correlate the employee's performance. As such, the analyzing step may not only determine which employment metrics should be included within second set of employment metrics 63, the algorithm may also determine a relative weight of each employment metric. For example, the analysis may determine that communication style 51 should be weighted twice as much as team building style 53 within the formula used to determine success indicator 57. Inasmuch as this analysis and correlation may be done for every elapsed amount of time equal to the predetermined time span, not only may employment metrics move into and out of second set of employment metrics 63 based on their influence on determining or indicating the overall performance score 49, the relative weights of the employment metrics contained within second set of employment metrics 63 may also change over time depending on the underlying needs and changes within organization 2.

Once second set of employment metrics 63 has been converted into success indicators 57 for each employee in organization 2, performance score 49 and success indicator 57 may be merged into a merged score, referred to in FIG. 3 as adjusted success ranking 59. FIG. 3 illustrates the merge technique as a simple addition between performance score 49 and success indicator 57. However, any merging technique may be used, including averaging the two scores or weighting one score relative to the other and adding the two to arrive at adjusted success ranking 59. The merging formula may be specified by organization 2 explicitly or may be predetermined and static within system 1. Further, system 1 or organization 2 may update or change the merging formula as needed.

The final step in the method for evaluating the employees of organization 2 is to provide one or more of performance score 49, success indicator 57, and adjusted success ranking 59 for each employee to organization 2. This information is extremely valuable to organization 2 as it provides not only the current performance of each employee as performance score 49, but an indicator of future performance found in success indicator 57, as well as the general overall success ranking of each employee within adjusted success ranking 59.

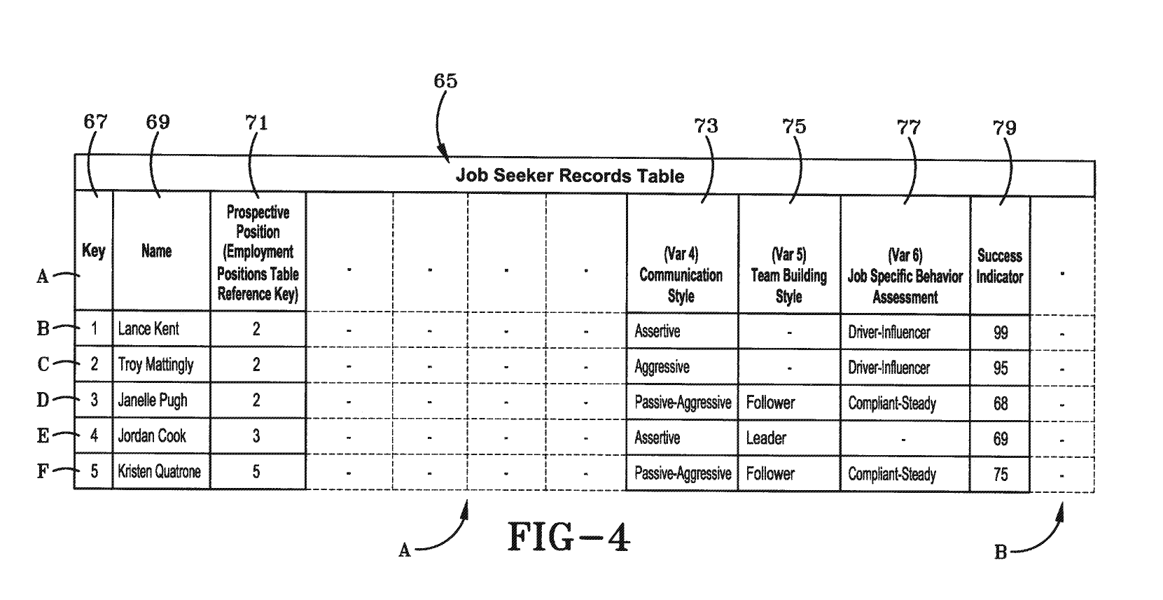

The above techniques and methods may be used to help evaluate job seekers for an employment position at organization 2. As shown in FIG. 4, job seeker records 9 may be embodied in a job seeker records table 65 within database 3. Job seeker records table 65 includes a key column 67 for use in referencing the associated row in job seeker records table 65 in other database tables within database 3. Job seeker records table 65 further includes a column for storing a job seekers name 69. Job seeker records table 65 also includes a reference key to the employment position records table 25 to signify which position within organization 2 the particular job seeker is seeking to fill. As such, a column for designating a prospective position 71 is included in job seeker records table 65. For example, row C of job seeker records table 65 reflects that “Troy Mattingly” is seeking to fill the position having the reference key of 2 within employment position records table 25. As shown in FIG. 2, key 27 equal to 2 within employment position table 25 reflects the job title of “Phone Operator—Level 2” in the department of “Customer Service” at the location of “Pittsburgh, Pa.”. Job seeker records table 65 further includes a column directed to the communication style 73, team building style 75, and job specific behavior assessment 77. Finally, job seeker records table 65 includes a column for a success indictor 79 of the respective job seeker.

Note that several employment metrics found in employee records table 35 are absent from job seeker records table 65, as indicated at Arrow A and Arrow B. These absent employment metrics are those that cannot or are not capable of being acquired at the job seeker stage. For example, a job seeker would not be able to supply an employment metric of supervisor review score 43, attendance 45, or disciplinary information 47. Further, inasmuch as many or all variables found within first set of employment metrics 61 are absent or not available, performance score 49 is also absent from job seeker records table 65, as performance score 49 is calculated and converted from employment metrics which are not available from a job seeker. However, one of the features of system 1 is directed to capturing at least one or more of the employment metrics found within second set of employment metrics 63 at the job seeker stage and populating job seeker records table 65 with this information. Further, one of the primary benefits of system 1 is directed to applying the formula for converting second set of employment metrics 63 into success indicator 57 and using this same formula with whatever employment metrics are available from a job seeker to derive success indicator 79. Success indicator 79 is thereafter presented to organization 2 for use in determining and evaluating a job seeker for an employment position at organization 2. Under a best case scenario, all employment metrics found in second set of employment metrics 63 are supplied by each job seeker to ensure the most accurate value of success indicator 79. However, as shown in cell 75b, 75c, and 77e of job seeker records table 65, often times an individual job seeker is unable to provide every employment metric found within second set of employment metrics 63. In this scenario, system 1 continues to apply the formula for converting second set of employment metrics 63 into success indicator 79 using any values available for employment metrics found within second set of employment metrics 63. The success indicator 79 derived from incomplete data may still be beneficial to organization 2 in determining whether a particular job seeker should be considered for an employment position at organization 2.

In general, job seekers typically provide some amount of information to an organization when applying for an employment position. The standard information such as name, address, phone number, is captured by query module 13 and passed to database 3 for storage in job seeker records 9. However, system 1 may be configured to administer a test to the job seeker to acquire additional information or assess the job seeker. The test may be of the form of a personality test, including but not limited to “DISC” style testing. The test may be of the form of a behavior analysis test, a general assessment test, or any other test or combination of tests directed to the personality, mentality, or behavior of the job seeker. The results of this testing may be entered into database 3 and used within second set of employment metrics 63 for determination of success indicator 79 of the job seeker.

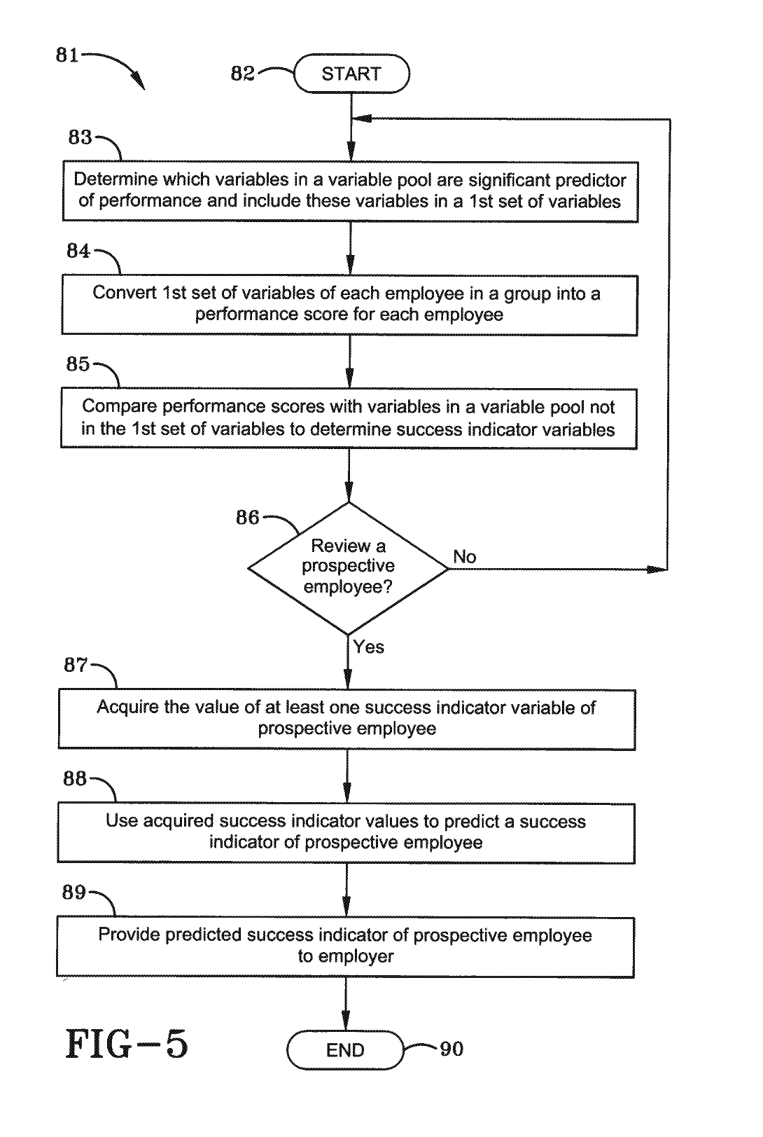

As shown in FIG. 5, a method 81 is shown for evaluating employees in organization 2 as well as a job seeker for an employment position within organization 2. Method 81 begins at a step 82 and proceeds to a step 83. Step 83 determines which variables in a variable pool are significant predictors of performance and flags these variables for inclusion within a first set of variables. Variables within method 81 equate to all of the data points collected on employees within organization 2 over the lifetime of the employment relationship between the employee and organization 2. Variables within method 81 equate to the employment metrics described previously. Method 81 uses variables and variable pool interchangeably with the terminology of “employment metrics” and “pool of employment metrics”. After step 83 determines which variables in the variable pool should be included within the first set of variables, step 83 proceeds to a step 84. Step 84 converts the first set of variables for each employee in a grouping of employees into a performance score for each employee. The grouping within step 84 may be by department, location, or the entire set of employees available through system 1. If organization 2 wishes to view the performance scores of any employees within a certain group, an administrator of system 1 may indicate this group and select the appropriate employees from database 3. This may be beneficial to organization 2 to determine the relative performance of a group. Organization 2 may even average or correlate all of the performance scores for each employee in the group into one general overall performance score of the group which may allow organization 2 to compare the performance between groups of employees.

After step 84 converts the first set of variables for each employee in a group into a performance score for each employee, step 84 proceeds to a step 85. Within step 85, system 1 compares the performance scores with variables in the variable pool which are not within the first set of variables to determine which of these variables should be considered success indicator variables. Step 85 may then categorize these success indicator variables into a second set of variables for use within system 1. Further, step 85 may then utilize the second set of variables to determine a success indicator for each employee within the group or within organization 2, as discussed above. Step 85 then proceeds to a step 86, whereby a determination is made as to whether organization 2 needs to review of prospective employee. If it is determined at step 86 that organization 2 does not need to review a prospective employee, step 86 proceeds back to step 83. Conversely, if organization 2 does need to review a prospective employee, step 86 proceeds to a step 87. Step 87 acquires the value of at least 1 success indicator variable of the prospective employee. Under a best case scenario, step 87 acquires a value for all of the success indicator variables for the prospective employee. As discussed above, the more values acquired for a prospective employee with respect to the second set of variables, the better and more accurate the resulting success indicator will be. After step 87 acquires as many values as possible for the prospective employee, step 87 proceeds to a step 88. Step 88 uses the acquired success indicator values to predict a success indicator of the prospective employee. Step 88 thereafter proceeds to a step 89. Step 89 provides the predicted success indicator of the prospective employee to organization 2 for use in evaluating and reviewing the prospective employee. After the success indicator is provided to organization 2, step 89 proceeds to a step 90, whereby method 81 ends. The flow chart of FIG. 5 may alternatively show step 89 proceeding back to step 83 to reflect the ongoing constant analysis of employee data and trends within system 1.

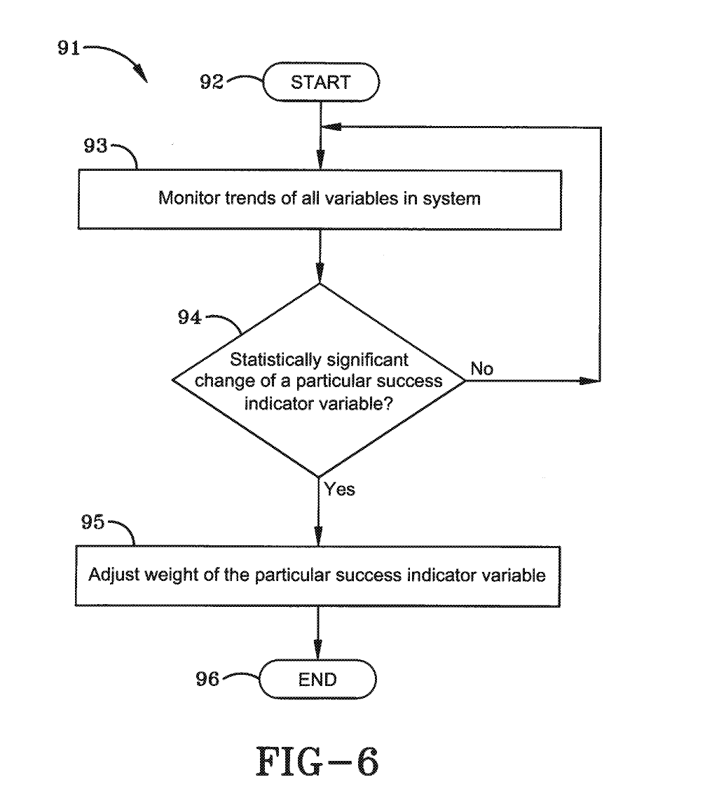

As shown in FIG. 6, a method 91 is provided for use in predicting the needs of organization 2 by way of system 1. Method 91 begins at a step 92 which initiates method 91 and proceeds to a step 93. Step 93 monitors all of the variables within system 1, specifically data points and employment metrics regarding employees within organization 2, whether or not these variables are used in the calculation of performance scores or success indicators. During the monitoring of variables within system 1, step 93 works in conjunction with a step 94, which determines whether a statistically significant change of a particular variable is noted. If this particular variable is a success indicator variable, step 94 proceeds to a step 95. If the change does not relate to a particular success indicator variable, namely, those variables contained within second set of employment metrics 63, step 94 proceeds back to step 93. Within step 95, the relative weight of the particular success indicator variable is adjusted to reflect the change in the overall variable within system 1. Step 95 then proceeds to a step 96 which ends method 91. Method 91 is useful for predicting the needs of organization 2 by changing the weights of employment metrics used to derive success indicators to account for changes in the overall aggregate amount or value of the variable. For example, if system 1 determines that a particular skill set A is a predictor of success for a position, method 91 monitors skill set A in addition to all the other metrics within system 1. If, due to employee turnover or attrition, employees within organization 2 with skill set A decreases, method 91 notes this trend and increases the weight of skill set A when evaluating potential employees and deriving their respective success indicators to make up for this deficit within organization 2. As such, system 1 may react and predict organizational needs before deficiencies occur within organization 2 and automatically help organization 2 correct these issues by illustrating which prospective job seekers best address the issue.

With respect to method 91, rather than step 95 adjusting the weight of a particular success indicator variable, step 93, step 94, and step 95 may be adjusted or altered to monitor each employee individually and alert a supervisor if system 1 recognizes that a trend at the individual employee level has occurred or a statistically significant change in an employee's performance score 49 or success indicator 57 has occurred. For example, if a particular employee of organization 2 experiences a drop in performance score 49 and adjusted success ranking 59 due to several disciplinary actions and several days of missed work were reflected in attendance column 45, a supervisor of that particular employee may be alerted as these deficiencies would impact that employee's performance score 49 and adjusted success ranking 59. Alternatively, human resources may be alerted when system 1 notes a statistically significant change in a particular employee's performance score 49, success indicator 57, and/or adjusted success ranking 59. A statistically significant change may indicate an underlying problem or another issue that human resources may need to address.

With respect to prospective employees and the techniques for evaluating prospective employees provided by system 1, a performance score at the position level, referred to hereinafter as the position score, may be derived and provided to the hiring entity for use in reviewing a prospective employee for that particular position. For example, a hiring entity may be provided the information from system 1 that a position A in organization 2 has a position score of 86. This position score may be calculated by averaging the performance scores of all of the employees assigned to that general position within organization 2. Alternatively, any mechanism or formula may be used to derive a position score within organization 2. In light of the example, if a hiring entity is presented with a position score of 86 for a particular position, any prospective employee may be compared to the position score for the position to determine the prospective employee's relative value if filling that position. Similarly, each position may be assigned a position success indicator at the position level which may be compared directly to a prospective employee's success indicator. For example, if position A has a position success indicator of 86, a prospective employee having a success indicator of 90 would be seen as a beneficial hire for that position. Conversely, if a prospective employee has a success indicator of 80, that prospective employee may be a detriment at the position. As such, system 1 may determine how successful a particular prospective employee will be within organization 2 on a position by position basis.

While the formula for deriving success indicators may be derived from an organization wide prospective, system 1 may also provide different employment metrics within second set of employee metrics 63 at a location level, facility level, or any other grouping within organization 2. For example, organization 2 may have a warehouse facility where employees working at the warehouse facility have a success indicator derived from a second set of employment metrics 63 which does not include the employment metric of communication style. It may be that workers within the warehouse do not communicate frequently with other workers within the warehouse, therefore the success of an employee at the warehouse may not be accurately reflected when incorporating the employee's communication style into the success indicator formula. As such, system 1 may provide different formulas for determining success indicators for multiple categories or groupings within organization 2, including groupings such as position, geographic location, or team. In light of this, system 1 may provide a hiring entity a prospective employee's success indicator within each category and derived from separate success indicator formulas specific to that category. For example, given the job requirements at a facility 1 compared to a facility 2, facility 1 incorporates different employment metrics within facility l′s second set of employment metrics 63 when compared to facility 2. A hiring entity may calculate a prospective employee's success indicator using the formula applicable at facility 1 as well as the formula applicable for facility 2. This will necessarily provide different success indicators for the prospective employee with respect to facility 1 and facility 2 and provides the hiring entity with knowledge of whether the prospective employee may be more successful at one facility over the other. As such, system 1 provides extremely accurate information to a hiring entity with respect to where a prospective employee may be successful within organization 2.

“Logic,” “logic circuitry,” or “logic circuit,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the present invention has been described in connection with the preferred embodiments of the various figures, it is to be understood that other similar embodiments may be used or modifications and additions may be made to the described embodiment for performing the same function of the present invention without deviating there from. Therefore, the present invention should not be limited to any single embodiment, but rather construed in breadth and scope in accordance with the recitation of the appended claims.

1. A method for evaluating a plurality of employees in an organization, the method comprising the steps of:
selecting a first set of employment metrics from a pool of employment metrics for each employee in the plurality of employees in the organization;
converting the first set of employment metrics for each employee in the plurality of employees into a performance score for the employee;
selecting a second set of employment metrics from the pool of employment metrics by correlating the performance score of each employee in the plurality of employees with each employment metric in the pool of employment metrics to determine which employment metrics in the pool of employment metrics are indicative of the performance score;
converting the second set of employment metrics for each employee in the plurality of employees into a success indicator for the employee; and
providing the performance score and the success indicator for each employee in the plurality of employees to the organization.

2. The method of claim 1, further comprising the step of merging the performance score and the success indicator for each employee into a merged score and providing the merged score for each employee in the plurality of employees to the organization.

3. The method of claim 2, further comprising the step of ranking each employee in the plurality of employees by one of the performance score, the success indicator, and the merged score and providing the ranking to the organization.

4. The method of claim 1, further comprising the steps of:
acquiring at least one acquired employment metric in the first set of employment metrics for a prospective employee at the organization;
converting the at least one acquired employment metric into a performance score for the prospective employee; and
providing the performance score for the prospective employee to the organization for use in evaluating the prospective employee for an employment position at the organization.

5. The method of claim 1, further comprising the steps of:
acquiring at least one acquired employment metric in the second set of employment metrics for a prospective employee at the organization;
converting the at least one acquired employment metric into a success indicator for the prospective employee; and
providing the success indicator for the prospective employee to the organization for use in evaluating the prospective employee for a position at the organization.

6. The method of claim 5, further comprising the steps of:
considering the prospective employee for a particular position within the organization;
determining which employees in the plurality of employees work in the particular position; and
comparing the success indicator of the prospective employee to one of the performance scores and the success indicators of the employees in the plurality of employees that work in the particular position to evaluate the prospective employee for the particular position.

7. The method of claim 5, further comprising the steps of:
considering the prospective employee for a particular position within the organization;
determining which employees in the plurality of employees work in the particular position;
deriving a position score for the particular position by incorporating one or both of the performance scores and the success indicators of the employees in the plurality of employees that work in the particular position into the position score for the particular position; and
comparing the success indicator of the prospective employee to the position score to evaluate the prospective employee for the particular position.

8. The method of claim 5, further comprising the steps of:
deriving a position score for each position in a plurality of positions by incorporating one or both of the performance scores and the success indicators of the employees in the plurality of employees assigned to the respective position;
comparing the success indicator of the prospective employee to each position score to evaluate the prospective employee for each position in the plurality of positions; and
providing a match position in the plurality of positions to the organization, whereby the match position provides the position score closest to the success indicator of the prospective employee.

9. The method of claim 1, further comprising the steps of:
monitoring each employment metric in the first set of employment metrics;
determining when a particular employment metric in the first set of employment metrics moves outside of a range; and
adjusting the weight of the particular employment metric when converting the first set of employment metrics into the performance score.

10. The method of claim 1, further comprising the steps of:
monitoring each employment metric in the second set of employment metrics;
determining when a particular employment metric in the second set of employment metrics moves outside of a range; and
adjusting the weight of the particular employment metric when converting the second set of employment metrics into the success indicator.

11. The method of claim 1, further comprising the steps of:
determining a time span; and
recalculating one or both of the performance score and the success indicator for each employee in the plurality of employees for every elapsed amount of time equal to the time span.

12. A system comprising:
a database, wherein the database includes a plurality of data records, wherein a first data record in the plurality of data records represents a current employee at an organization, a performance score for the current employee, a success indicator for the employee, and a pool of variables associated with the current employee;
a conversion module in communication with the database, wherein the conversion module is configured to convert a first plurality of variables in the pool of variables for the current employee into the performance score and store the performance score in the database;
wherein the conversion module is configured to correlate the performance score with the remaining variables in the pool of variables not in the first plurality of variables to determine which of the remaining variables in the pool of variables are indicative of the performance score and to consider the indicative variables as members of a second plurality of variables in the pool of variables; and
wherein the conversion module is configured to convert the second plurality of variables in the pool of variables for the current employee into the success indicator and store the success indicator in the database.

13. The system of claim 12, wherein a second data record in the plurality of data records represents a job seeker seeking employment at the organization, a set of job seeker variables, and a job seeker success indicator, and wherein the set of job seeker variables are equal to the second plurality of variables in the pool of variables.

14. The system of claim 13, further comprising a query module in communication with the database, wherein the query module is configured query the job seeker for a value for at least one variable in set of job seeker variables and store the value in the database.

15. The system of claim 14, further comprising a prediction module in communication with the database, wherein the prediction module is configured to convert the value into the job seeker success indicator and store the job seeker success indicator in the database.

16. A method of evaluating a job seeker for an employment position at an organization, the method comprising the steps of:
associating a first set of employment metrics with each employee in a plurality of employees in the organization;
associating a second set of employment metrics with each employee in the plurality of employees;
converting the first set of employment metrics for each employee in the plurality of employees into a performance score for the employee;
determining a weight for each employment metric in the second set of employment metrics by comparing the differences between the performance score of each employee in the plurality of employees and the associated second set of employment metrics of the employee;
acquiring a value for at least one employment metric in the second set of employment metrics for the job seeker;
converting the at least one employment metric in the second set of employment metrics into a success indicator by applying the determined weight for the at least one employment metric in the second set of employment metrics; and
providing the success indicator to the organization.

17. The method of claim 16, further comprising the step of administering a test to the job seeker to acquire the value.

18. The method of claim 17, further comprising the step of administering one of a personality test and a behavioral analysis test as the test.

19. The method of claim 18, further comprising the step of administering a DISC assessment test as the test.

20. The method of claim 16, further comprising the steps of:
determining a time span; and
updating the determined weight for each employment metric in the second set of employment metrics for every elapsed amount of time equal to the time span.
